(19) United States
(12) Patent Application Publication
(10) Pub. No.: US 2026/0289761 A1
(43) Pub. Date: Sep. 24, 2026

(54) SELF HEALING TARGET AND A METHOD AND SYSTEM FOR IMPACT IDENTIFICATION

(71) Applicant: DA Targets LLC, Allentown, PA (US)

(72) Inventors: Ryan Seidel, New Tripoli, PA (US); Nathan Boring, New Tripoli, PA (US)

(21) Appl. No.: 19/570,107

(22) Filed: Mar. 17, 2026

Related U.S. Application Data
(60) Provisional application No. 63/774,103, filed on Mar. 19, 2025.

(51) Int. Cl. G06T 7/00

(52) U.S. Cl. CPC G06T 7/0004; G06T 2207/10048

(57) ABSTRACT

The present invention is a computer implemented method comprising: collecting images from at least one sensor, wherein the sensor is collecting images of a target; identifying a change in a physical property of the target which is identified in a change in the images collected by the at least one sensor; calculating that the target experienced an impact at a predetermined location based on the change in the images collected; and registering an impact location to a user interface.

### CROSS REFERENCE TO RELATED APPLICATIONS

This application is a continuation-in-part (and claims the benefit of priority under 35 USC 120) of U.S. application No. 63/774,103 filed Mar. 19, 2025, now pending. The disclosure of the prior applications is considered part of (and is incorporated by reference in) the disclosure of this application.

### BACKGROUND OF THE INVENTION

The present invention relates to a target and a system to hit indication, and more particularly to a target with self-healing capabilities and thermal contrast hit indication and a method and system to processing impact locations.

Thermal targeting systems are widely used in military, law enforcement, and civilian applications. Traditional targets do not provide sufficient thermal contrast, making it difficult for operators using infrared (IR) and thermal optics to acquire and engage them effectively. Existing targets designed to provide thermal contrast through active or passive means lack self-healing properties, resulting in short lifespans. Furthermore, most standard targets do not provide a visible or thermal indication of hits in real time.

Detecting hits on targets, whether for competitive shooting, military training, or recreational activities, has always presented unique challenges. Accurate and immediate hit detection is crucial for evaluating performance, training effectiveness, and maintaining an engaging experience for users. However, existing target solutions, particularly self-healing and non-healing targets, have significant limitations that hinder their utility and reliability.

Self-healing targets are an innovative solution designed to extend the lifespan of physical targets by automatically resealing punctures caused by projectiles. While this feature enhances durability, it also makes hit detection more challenging. Traditional self-healing material minimizes visual and structural evidence of projectile impact, thereby requiring advanced systems to accurately and reliably detect hits without relying on manual inspection or visible markers. This challenge is further exacerbated under conditions of rapid-fire shooting or when multiple hits occur in quick succession, as the material heals almost instantly after impact.

Conversely, traditional non-healing targets offer easier visual verification of hits, but they suffer from several drawbacks. These targets degrade quickly under repeated use, necessitating frequent replacement and increasing operational costs. Additionally, they generate waste and environmental concerns due to their disposable nature. Non-healing targets also lack the resilience needed for extended training sessions or high-intensity shooting exercises, limiting their practicality in certain use cases.

Steel targets can offer immediate feedback without generating waste, but present safety concerns in close quarters or indoor scenarios. For effective visual indication of impacts, steel targets must be repainted between hits, which introduces wasted time in a training scenario and is impractical in long-range scenarios.

Moreover, existing hit-detection systems for both self-healing and non-healing targets often rely on external sensors, such as acoustic or vibration detectors, which can be prone to false positives or negatives. These systems may struggle to distinguish between genuine hits and environmental noise, reducing their reliability. Furthermore, integrating such systems with targets can increase complexity, cost, and maintenance requirements.

It is desired to have self-healing and thermal contrast indicator target and a system to detect the impact locations and provide real time data.

### SUMMARY

In a first embodiment, the present invention is a computer-implemented method comprising: collecting, by at least one processor, images from at least one sensor, wherein the sensor is collecting images of a target; identifying, by at the least one processors, a change in a physical property of the target which is identified in a change in the images collected by the at least one sensor; calculating, by at the least one processors, that the target experienced an impact at a predetermined location based on the change in the images collected; and registering, by at the least one processors, an impact location to a user interface.

In a second embodiment, the present invention is a computer program product comprising one or more computer non-transitory readable storage media and program instructions stored on the one or more computer non-transitory readable storage media, the program instructions comprising: program instructions to collect frame by frame images of a target; program instructions to identify a physical change in the frame by frame images of the target; program instructions to analyze the physical change in the frame by frame images of the target to determine if an impact occurred and an impact location; and program instructions to process the impact occurrence and the impact location to create a set of data related to the impact occurrence and impact location which is provided to a user interface.

In a third embodiment, the present invention is a system comprising: one or more computer processors, one or more computer non-transitory readable storage media, and program instructions stored on the one or more computer non-transitory readable storage media for execution by, at least one of the one or more processors, the program instructions comprising: analyzing images collected by at least one sensor, wherein the images are related to a target; determining if a physical change in the target occurred and is identifiable by the at least one sensor, analyzing the physical change in the target to determine an impact location; and presenting the impact location to a user through a user interface.

### BRIEF DESCRIPTION OF THE DRAWINGS

FIG. 1 depicts an isometric view of a target system, in accordance with one embodiment of the present invention.

FIG. 2 depicts an exploded view of the target system, in accordance with one embodiment of the present invention.

FIG. 3 depicts an image of a target base plate, in accordance with one embodiment of the present invention.

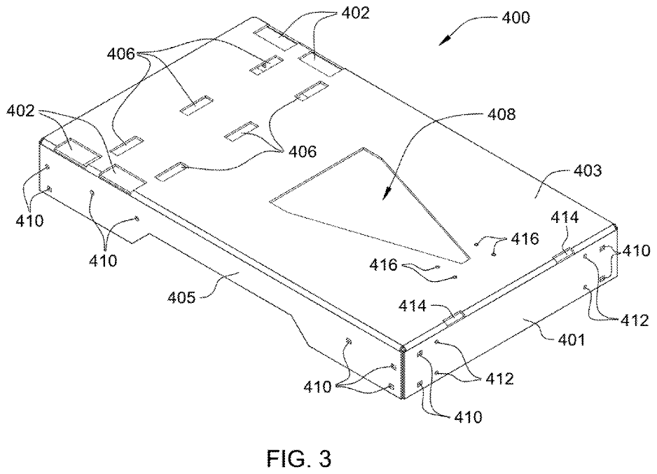

FIG. 4 depicts an image of a leg, in accordance with one embodiment of the present invention.

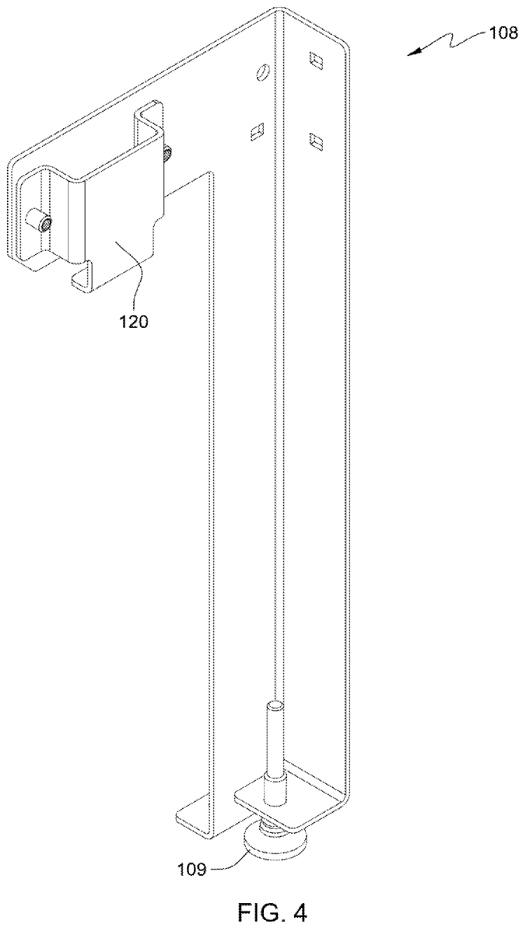

FIG. 5 depicts a computing node according to an embodiment of the present invention.

FIG. 6 depicts a block diagram depicting a computing environment according to an embodiment of the present invention.

FIG. 7 depicts a flow chart of the operation of the target system, in accordance with one embodiment of the present invention.

### DETAILED DESCRIPTION OF THE INVENTION

The present invention relates to firearm and training targets and method of operation, particularly those used with thermal imaging and night vision targeting systems which detect Long Wave Infrared (LWIR) and Mid Wave Infrared (MWIR) wavelengths. More specifically, the invention provides a method and apparatus for heating a target or its perimeter to enhance contrast against the surroundings for thermal targeting while incorporating self-healing material properties and temporary hit indication at the point of impact. The device and system can be used for long range shooting, low-light/no-light shooting, firearms competitions, or a variety of settings where impact identification is important. The device, system, and method are advantageous because they are all for complex courses of fire and are able to accurately and with minimal human interaction present the data to the shooter(s) for review and analysis.

Detailed aspects and applications of the disclosure are described below in the following drawings and detailed description of the technology. Unless specifically noted, it is intended that the words and phrases in the specification and the claims be given their plain, ordinary, and accustomed meaning to those of ordinary skill in the applicable arts. The present invention provides an advantage for repeated impact detection of targets that lack permanent physical evidence of prior impacts, through the use of a thermal activated target and a computing system able to process video/image data related to changes in the target.

In the following description, and for the purposes of explanation, numerous specific details are set forth in order to provide a thorough understanding of the various aspects of the disclosure. It will be understood, however, by those skilled in the relevant arts, that embodiments of the technology disclosed herein may be practiced without these specific details. It should be noted that there are many different and alternative configurations, devices, and technologies to which the disclosed technologies may be applied. The full scope of the technology disclosed herein is not limited to the examples that are described below.

The singular forms “a,” “an,” and “the” include plural referents unless the context clearly dictates otherwise. Thus, for example, reference to “a step” includes reference to one or more of such steps.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented but have been omitted for purposes of brevity.

When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

Throughout the description and claims of this specification, the words “comprise” and “contain” and variations of the words, for example “comprising” and “comprises”, mean “including but not limited to”, and are not intended to (and do not) exclude other components.

As required, detailed embodiments of the present disclosure are included herein. It is to be understood that the disclosed embodiments are merely exemplary of the invention that may be embodied in various forms. Therefore, specific structural and functional details disclosed herein are not to be interpreted as limits, but merely as a basis for teaching one skilled in the art to employ the present invention. The specific examples below will enable the disclosure to be better understood. However, they are given merely by way of guidance and do not imply any limitation.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

More specifically, this disclosure, its aspects and embodiments, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates, which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

This invention is a system comprising hardware components and software that work together to detect the impact of projectiles on a target based upon the thermal signature of the point of impact on the target immediately after impact. The invention is especially suited for use with self-healing polymer targets where the projectile passes through the target, leaving essentially only a thermal record of the impact, which dissipates and fades over time. The software component of the invention is able to compare current thermal images with prior images to detect changes, indicative of a new impact, especially when multiple projectile impacts occur in a short amount of time and in close proximity. The invention can relay hit information immediately to the user via a visual or auditory signal and digitally by transmitting image and other data to a secondary computing device. Finally, the invention can provide aggregated data from multiple targets for analysis or scoring complex courses of fire.

There is a need for a target that maintains high visibility through thermal optics, is durable enough to withstand multiple impacts, and provides a temporary hit indication that fades over time.

The need for a robust and efficient solution to detect hits on self-healing targets is critical to overcoming these challenges. Such a solution would provide a seamless, accurate, and cost-effective way to track projectile impacts while preserving the durability and environmental benefits of self-healing materials. By addressing these limitations, the invention described herein aims to revolutionize the hit-detection landscape for targets used in shooting-related applications.

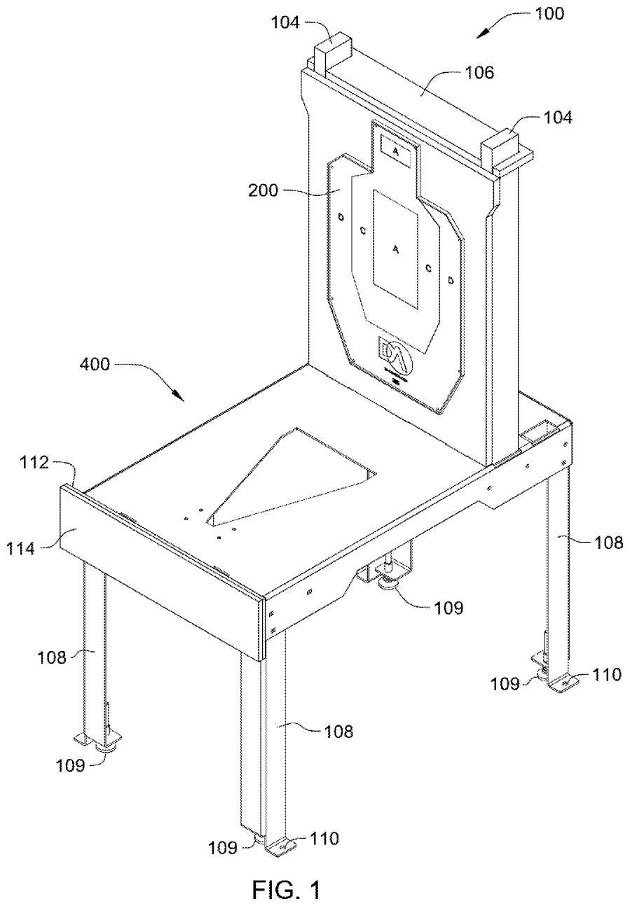

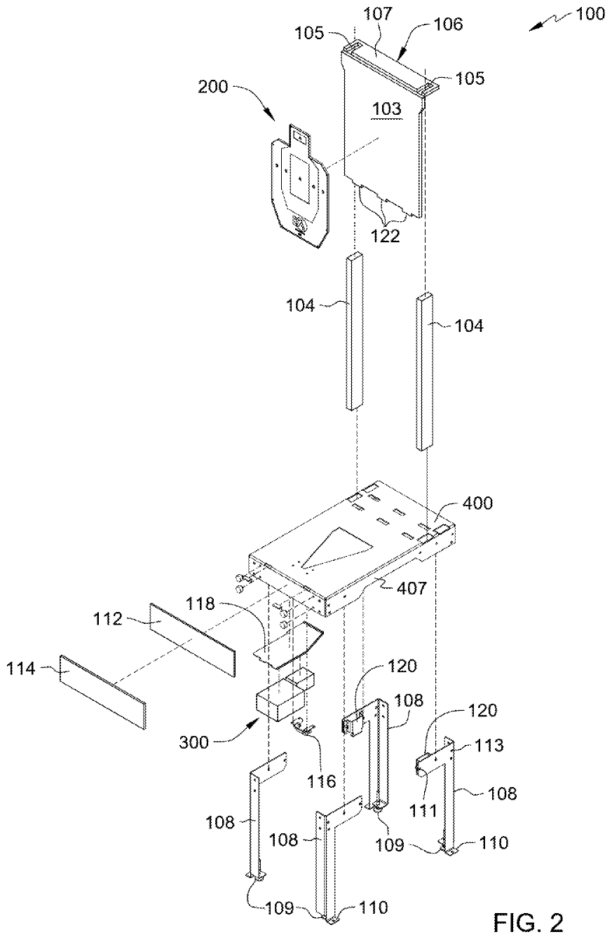

FIGS. 1-2 depict images of the target system 100, in accordance with one embodiment of the present invention.

The target system 100 consists of a frame, a target 200 and a computing device 300.

The frame is comprised of a base plate 400, a set of legs 108, a back plate 106, a set of back plate supports 104, a first guard plate 114, a second guard plate 112, a cover shield 118, and the computing device 300 mounting hardware 116.

The base plate 400 provides for the main support for the target system 100. The base plate 400 is a structure with a top surface 403, a front surface 401, a rear surface 409, a side surface 405 and a side surface 407. On the top surface 403 is an aperture 408, apertures 406, and apertures 402. In the present embodiment, there are two sets of apertures 402 towards the rear surface 409 and are sized to receive supports 104. Apertures 402 are positioned relative to the location of a support holder 120. In the depicted embodiment, apertures 406 are positioned distal to rear surface 409 and are set in two rows of three apertures. Apertures 406 are sized and positioned to receive protrusions 122 of back plate 106. Aperture 408 is sized and positioned to allow for the computing device 300 to be able to view the entire target 200 to monitor all hits on the target 200.apertures 410 are present on the side surface 405 and 407 and the front surface 401. Apertures 410 are positioned to interface with apertures on the legs 108 so that a fastener can be used to secure the legs 108 to the base plate 400. Apertures 412 are positioned on the front surface 401 and are used to secure the guard plates 114 and 112 to the front of the target system 100 to provide added protection for the computing device 300. Apertures 416 are positioned relative to aperture 408 and are used to secure the computing device 300 to the base plate 400 via mounting hardware 116. Mounting hardware 116 is sized and shaped to fit securing around the computing device 300 and interface with apertures 416, where a fastener secures the mounting hardware 116 to the base plate 400.

Supports 104 are of a predetermined length and size to fit in apertures 402 and extend through the top of the back plate 106. The supports 104 provide the structural support for the back plate 106 so that the target 200 remains stationary while the target 200 is in use.

Back plate 106 provides the base for the target 200. Back plate 106 has front surface 103 with a top surface 107. The top surface 107 has two apertures 105 that are sized to receive supports 104. The back plate 106 has protrusions 122 that are sized to fit within the apertures 406 of the base plate 400.

Guard plates 114 and 112 are to provide added protection for the computing device 300 by be secured to the base plate 106 directly in front of the computing device 300. The guard plates 114 and 112 are of a size and thickness to stop a projectile from passing through the guard plates and into the computing device 300.

The set of legs 108 provides the structural support for the targeting system 100. In the depicted embodiment, four legs 108 are shown and are substantially similar in design. The legs 108 have an upper portion with a series of apertures 113 that interface with apertures 410 of the base plate 400, where fasteners secure the legs 108 to the base plate 400. Apertures 411 of the legs 108 interface the base plate 400 and support holder 120, so that a fastener can be used to secure the support holder 120 to the leg 108 and the leg 108 to the base plate 400. In the depicted embodiment, the rear two legs 108 have the support holder 120. The legs 108 have adjustable feet 109 to level the target system 100 on uneven ground, and feet 110 to secure the target system 100 to a surface for additional stability.

The cover shield 118 provides for protection for the computing device 300 by be positioned relative to apertures 408. In some instances, the projectile may ricochet off the target 200 directed towards the computing device 300, where the cover shield 118 will deflect the projectile away from the computing device 300. The cover shield is made from a material that allows for the computing device 300 to clearly see the target while providing adequate protection for the computing device 300 components.

Target 200 is secured to the back plate 106 and provides for the object at which the person is aiming for. In the depicted embodiment that target resembles a torso of a person with various portions (“A”, “C”, and “D”). The target 200 can be various shapes, sizes, and designs and the present embodiment is shown for exemplary purposes. The target 200 is made from a self-healing and thermally responsive material. The self-healing material is a resilient polymer or elastomer capable of closing after projectile penetration to extend target life. The temporary hit indication is a material or coating that reacts thermally or mechanically upon impact to momentarily highlight the point of impact before returning to its baseline state. The target 200 may have various emissivity coatings applied to the target to assist in the control of the emission and absorption of thermal radiation. In some embodiments, certain areas of the target 200 are coated with the emissivity coating while other areas are not.

In one embodiment, the target 200 is comprised of a heating element, a self-healing material, a coating, and a power source. The heating elements are an embedded or a surface-applied heating mechanisms to create thermal contrast. The power source is a device or system for providing power to heating elements that are embedded within an insulating polymer.

The method of heating the target 200 and/or perimeter utilizes electrically conductive heating elements, embedded resistive wires, or chemical heating methods to generate and maintain a temperature differential between the target 200 and its surroundings. The perimeter heating enhances target edge contrast, aiding in acquisition. The target 200 is composed of a self-sealing polymer or elastomer designed to close upon projectile impact. The material maintains structural integrity over multiple engagements. The temporary hit indication is comprised of a thermally responsive layer or mechanically reactive surface provides a momentary visual or thermal change upon impact. The change dissipates over time, allowing continuous use without requiring manual resetting.

In one embodiment, the process for manufacturing requires the target structure is fabricated using injection molding, layering of materials, casting, or additive manufacturing. Heating elements are integrated into the target material during manufacturing or attached mechanically to the target using specific designed attachment points, or a separate purpose-built mechanical device.

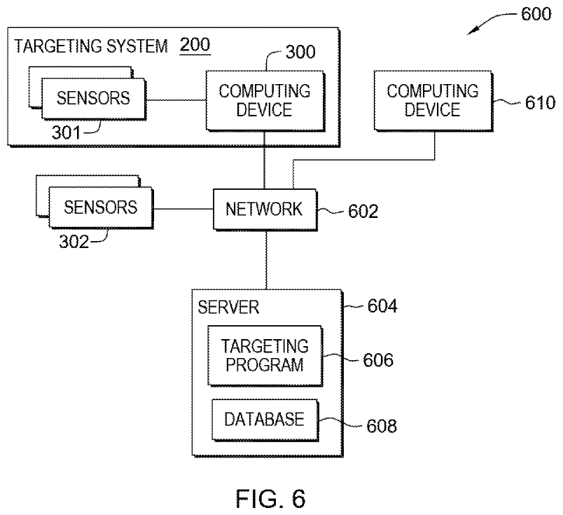

Computing device 300 provides for the data collection device that is able to detect impacts on the target, process the data associated with the impact, and send the data to a computing device for review of the impact(s). The computing device 300 is equipped with one or more sensors (sensors 301 in FIG. 6) capable of capturing thermal image data in the Long Wave Infrared (LWIR) and Mid-Wave (MWIR) Infrared wavelengths. The one or more sensors may collect data associated with the target 200, as well as data associated with the shooter. The one or more sensors is able to collect environmental data. A timing device. A processing unit or embedded system that collects raw data from the image sensors. A processing unit or embedded system to interpret raw image data from the image sensors and compare it with prior images and hit data. Secondary sensors, such as acoustic sensors or accelerometers, used to provide additional data to the processing unit to aid in interpretation or machine learning. Communication modules (e.g., Bluetooth, Wi-Fi, cellular, wired) to transmit data to additional computing devices for additional analysis. Apparatus for indicating hits (e.g., LED, mechanical flag, buzzer).

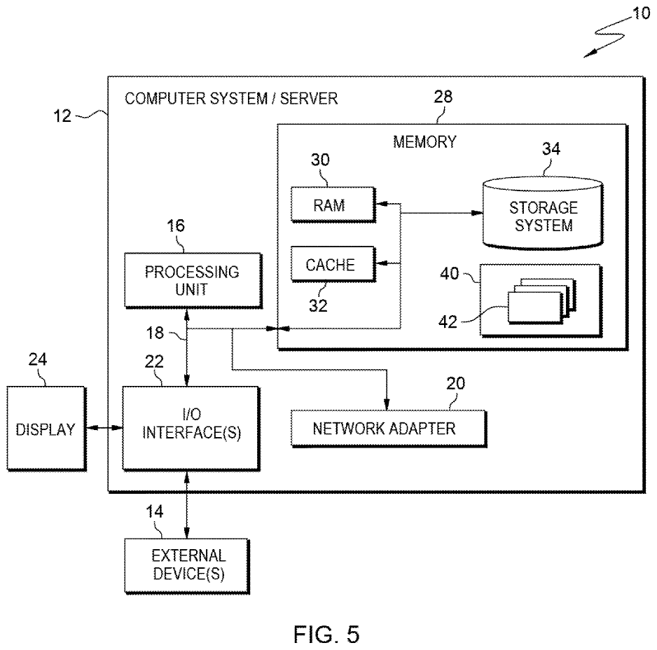

FIG. 5, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionalities set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed computing environments where tasks are performed by remote processing devices that are linked through a communications network. In a distributed computing environment, program modules may be located in both local and remote computer system storage media including memory storage devices.

Computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

FIG. 6 depicts a block diagram of a computing environment 600 in accordance with one embodiment of the present invention. FIG. 5 provides an illustration of one embodiment and does not imply any limitations regarding the environment in which different embodiments maybe implemented.

In the depicted embodiment, computing environment 600 includes network 602, computing device 300, computing device 610 server 604. Computing environment 100 may include additional servers, computers, or other devices not shown.

Network 102 may be a local area network (LAN), a wide area network (WAN) such as the Internet, any combination thereof, or any combination of connections and protocols that can support communications between patient computing device 104, personnel computing device 106, and server 604 in accordance with embodiments of the invention. Network 102 may include wired, wireless, or fiber optic connections.

Computing devices 300 and 610 may be a management server, a web server, or any other electronic device or computing system capable of processing program instructions and receiving and sending data. The computing devices 300 is connected to sensors 301 and sensors 302 and incorporated into target system 100. The sensors 301 and 302 are able to collect data (images and video) associated with LWIR and MWIR. In additional embodiments the sensors 301 and 302 are able to also collect various environmental data (audio, visual, speed, mechanical movement, etc.). Sensors 301 are integrated into the targeting system 200, whereas sensors 302 are integrated into the environment. Sensors 302 may be worn by the shooter (for example surface/muscle electromyography (EMG) sensors), attached to the weapon/firearm, they may be installed in the range or area where the target practice is occurring, or anywhere that is not directly attached to the targeting system 200. The computing device 610 is connected to network 602 and is external from the target system 100. In some embodiments, computing devices 300 and 610 may be a laptop computer, tablet computer, netbook computer, personal computer (PC), a desktop computer, or any programmable electronic device capable of communicating with computing devices 300, 610, and server 604 via network 102.

In the depicted embodiment, there are sensors 301 mounted on the targeting system 100 as well as mounted externally and are connected to network 602 and are able to communicate with server 604.

Server 604 may be a management server, a web server, or any other electronic device or computing system capable of processing program instructions and receiving and sending data. In other embodiments server 604 may be a laptop computer, tablet computer, netbook computer, personal computer (PC), a desktop computer, or any programmable electronic device capable of communicating with computing devices 300 and 610 via network 102. In one embodiment, server 604 may be a server computing system utilizing multiple computers as a server system, such as in a cloud computing environment. In one embodiment, server 604 represents a computing system utilizing clustered computers and components to act as a single pool of seamless resources. In the depicted embodiment targeting program 606 and database 114 are located on server 604. Server 604 may include components.

Targeting program 606 operates to perform an analysis on the impacts which occur between the projectiles and the target 200. In the depicted embodiment, targeting program 606 utilizes network 102 to access the computing devices 300 and 610 and communicates with database 608. In one embodiment, targeting program 606 resides on computing device 300. In other embodiments, targeting program 606 may be located on another server or computing device, provided Targeting program 606 has access to database 608.

Database 608 may be a repository that may be written to and/or read by Targeting program 606. Information gathered related to impacts from projectiles and target 200 may be stored in database 608. In one embodiment, database 608 is a database management system (DBMS) used to allow the definition, creation, querying, update, and administration of a database(s). In the depicted embodiment, database 608 resides on server 604. In other embodiments, database 608 resides on another server, or another computing device, provided that database 114 is accessible to Targeting program 606.

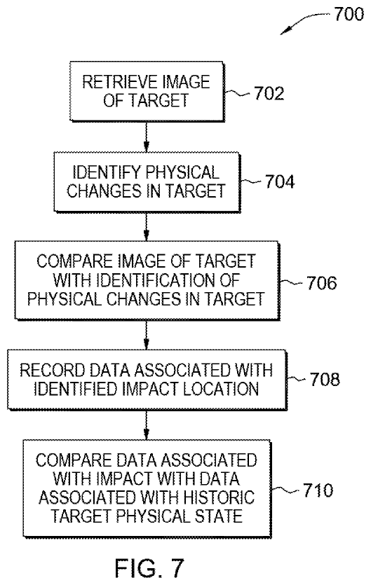

FIG. 7 shows flowchart 700 depicting a method according to the present invention. The method(s) and associated process(es) are now discussed, over the course of the following paragraphs, with extensive reference to FIG. 2, in accordance with one embodiment of the present invention.

The program(s) described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

In step 702, targeting program 606 retrieves images (frame by frame) (or videos) of the target 200. The target 200 design is precalibrated by the targeting program 606 based on the design of the target and different areas of the target. For example, in the embodiments shown, the target 200 depicts a torso and head of a target and the targeting program 606 is able to identify the different areas of the target. The target may be circular in design or may depict various other animals or shapes. The retrieval of these images assists the targeting program 606 to establish a baseline of the target 200 both physically and thermally as well as determine the edges of the target to set the outer limits of where hits are registered. The targeting program 606 is also able to identify is an area of the target has an emissivity coating and map the target 200 (e.g., zone mapping). The targeting program 606 is also able to determine how that emissivity coating affects the heat transfer and cooling curve of residual impact energy. The targeting program 606 uses computing device 300 with integrated sensors 301 to analyze the images, thermal images, and secondary sensors to collect data associated with the target 200 and any changes in the target 200. The targeting program 606 may retrieve images at a predetermined interval or at predetermined times. Each image includes a set of data associated with the state of the target 200 at the time the image is retrieved. The targeting program 606 is able to collect data from a variety of sensors and data sources. In some embodiments, the targeting program 606, through the retrieved images, initializes a heat map baseline and continuous update via time-weighted averaging during non-impact intervals, and retirement when the baseline converges to global ambient.

In step 704, targeting program 606 identifies an impact of the target 200 by a projectile. Through the identification of a change in the images received by the targeting program 606. An impact is identified by a predetermined change in the target 200 or data collected by the secondary sensors. In some embodiments, algorithms are used to adapt detection thresholds autonomously (i.e., machine learning) or via user configuration and training. The changes in the image may be based on per-location thermal changes and the cooling curve of residual impact energy. The detection of a hit does not require that the projectile penetrate the target 200 based on the detection of kinetic energy transferred from the projectile to the target 200. The targeting program 606 through the computing device 300 is able to perform Real-time hit detection in any ambient temperature through the analysis of images and video from LWIR and MWIR image sensors. Real-time hit detection in any lighting condition through detection and analysis of images and video from LWIR and MWIR image sensors. The targeting program 606 uses algorithms in combination with the computing device 300 hardware components to detect typical temperature changes and thermal signature of the current shooting session by observing prior hits for the purpose of accurately distinguishing new hits, even when impact is in essentially the same location. In the embodiments, where two hits are substantially the same location, the thermal signature or heat signature is different than if the location was only hit once. The targeting program 606 based on the collected images is able to tell the changes in the thermal signature or the temperature change between a single hit and multiple hits in the same location on the target 200. Also using the time stamps on the collected images, if there is enough time for the target 200 to return to its normal thermal signature, and a hit in the same location occurs, the targeting program 606 is able to determine the multiple hits using the time stamps as well. When the target 200 does not retain permanent physical evidence of prior impacts (e.g., a self-healing), the targeting program 606 maintains a per-location thermal baseline for each confirmed impact position. Any new impacts are recorded at the specific location are detected as incremental thermal rises above the local and/or established baseline thermal reading, and not against global ambient temperatures. This enables discrimination of a new impact from the residual cooling heat of a prior impact. The targeting program 606 is able to detect the location of each hit and the time between each hit on the target 200.

In some embodiments, the projectile does not penetrate the target 200, so there is no physical entry and exit mark on the target 200. The targeting program 606 detects impacts based solely on surface thermal energy resulting from kinetic energy transfer at the point of contact, and that this detection does not require projectile penetration, deformation, or permanent marking of the target surface. This may occur with specific projectiles, such as but not limited to, training rounds, marking rounds, rubber/polymer/foam less-lethal projectiles, and simunition/force-on-force rounds. The electronic hit record constitutes the only persistent evidence of any impact.

In step 706, targeting program 606 compares the images of the target 200 with the identification of the impact of the target 200 by the projectile. Through the comparison of the images, and with the secondary sensor data, the targeting program 606 is able to identify the most recent impact. The targeting program 606 is able to detect multiple calibers during the same course of fire on the same target. The targeting program 606 is able to detect the most recent impact versus an immediately prior impact, thus comparing to a constantly changing base state as energy from prior impacts dissipates into the environment or surrounding material. With the process of the targeting program 606 collecting images at predetermined intervals, the targeting program 606 is able to detect the cooling of the hit locations and the self-healing properties of the target do not negatively effect the collection of data.

In step 708, targeting program 606 records data associated with the projectile impact of the target 200. Through the images and the secondary sensors, the targeting program 606 is able to collect data associated with the impact and store this data while continuing to monitor the target for additional impacts and isolate the data associated with each of the impacts individually. The recorded data may be presented to a user through the user interface which shows real time impact location, time between impacts, and accuracy based on predetermined accuracy variables.

In step 710, targeting program 606, compares data associated with the impact of the projectile with historic data associated with historic impacts of the target 200. Through a user interface on computing device 610, the targeting program 606 presents insights, alerts, or visualized data (e.g., graphs, reports), related to each of the impacts (or all the impacts as a whole) including synchronizing input from multiple targets and detection sensors, as well as audio video or other relevant data. The targeting program 606 is able to track and synchronize impact data from multiple targets, and is able to provide play back, synchronize with external video, and provide raw data for historical analysis, analysis across multiple targets and sensors in the case of complex courses of fire, and scoring in the case of competition. This process is performed, in some embodiments, continuously on the target 200. In other embodiments, the process is performed for a predetermined time or until impacts are no longer detected for a predetermined time. In some instances, there is a start and stop action performed by a user or third party.

The user interface (UI) is provided to a device either integrated into the range or to a personal device that the shooter is able to use. The data collected and processed by the targeting program 606 is presented to the user in the user interface in a predetermined and through a user friend UI. Additional features in the UI allow the user to reset the target or “course” for another round of shooting. Based on the user resetting the target, the targeting program 606 creates a “zero” image of the target which all future calculations are based off of. For example, once the user is done with a round of shooting, the target 200 may not be back to the normal or “zero” heat signature and may still have an elevated heat signature. Once the user rests the target 200, the targeting program 606 establishes the new “zero” of the target 200 for the next round. This will avoid false positives or negatives for impacts. This is also advantageous because there is no need for the shooter or any other personnel walking down range possibility putting themselves in danger to rest the target, is what is typically required for other types of targets.

The targeting program 606 is able distinguish hits from one or more shooters. Based on the analysis of the multiple images collected, and the use of additional data received from various other sensors. Through both the timing, heat signals, sounds, user input data, or other data which can be collected by the sensor(s) the targeting program 606 is able to identify and process who shot each bullet/projectile and relay this information to the user interface.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

It will be further understood that various changes in the details, materials, and arrangements of the parts which have been described and illustrated in order to explain the nature of this invention may be made by those skilled in the art without departing from the scope of the invention as expressed in the following claims.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g., attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements, and/or substantial equivalents.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g., attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements, and/or substantial equivalents.

What is claimed is:

1. A computer-implemented method comprising:
collecting, by at least one processor, images from at least one sensor, wherein the sensor is collecting images of a target;
identifying, by at the least one processor, a change in a physical property of the target which is identified in a change in the images collected by the at least one sensor;
calculating, by at the least one processor, that the target experienced an impact at a predetermined location based on the change in the images collected; and
registering, by at the least one processor, an impact location to a user interface.

2. The computer-implemented method of claim 1, further comprising, processing, by the at least one processor, the impact location and providing the data to a user interface.

3. The computer-implemented method of claim 1, wherein the sensor is able to collect thermal imaging.

4. The computer-implemented method of claim 1, further comprising, analyzing, by one or more processors, an impact location baseline and physical property changes over time.

5. The computer-implemented method of claim 1, wherein the identification of the change in the physical property of the target, further comprises, monitoring, by the at least one processor, additional changes in the physical properties of the target to identify multiple impact locations.

6. The computer-implemented method of claim 1, further comprising, generating, by the at least one processor, a user interface depicting the target wherein all the impact locations are identified.

7. The computer-implemented method of claim 1, further comprising, monitoring, by the at least one processor, the physical properties of the target to determine when to reset the registration of the impact locations.

8. The computer-implemented method of claim 1, wherein the target has precalibrated configuration.

9. A computer program product comprising:
one or more computer non-transitory readable storage media and program instructions stored on the one or more computer non-transitory readable storage media, the program instructions comprising:
program instructions to collect frame by frame images of a target;
program instructions to identify a physical change in the frame by frame images of the target;
program instructions to detect threshold changes in the physical properties of the target;
program instructions to analyze the physical change in the frame by frame images and the threshold changes in the physical properties of the target to determine if an impact occurred and an impact location; and
program instructions to process the impact occurrence and the impact location to create a set of data related to the impact occurrence and impact location which is provided to a user interface.

10. The computer program product of claim 9, wherein a thermal imaging sensor is used to collect the frame by frame images of the target.

11. The computer program product of claim 9, further comprising, program instructions to create a map of the target.

12. The computer program product of claim 9, program instructions to detect an end of a round and establishing a reset baseline value for the target based on the physical properties of the target.

13. The computer program product of claim 9, program instructions to identify spatial properties to the impact occurrence in the target.

14. The computer program product of claim 10, wherein the thermal changes and the spatial properties of the impact occurrences are analyzed for individual impact occurrences.

15. The computer program product of claim 9, further comprising, creating a visual display of the impact occurrences in a user interface and scoring the impact occurrences based on a target design.

16. A system comprising:
one or more computer processors, one or more computer non-transitory readable storage media, and program instructions stored on the one or more computer non-transitory readable storage media for execution by, at least one of the one or more processors, the program instructions comprising:
analyzing images collected by at least one sensor, wherein the images are related to a target;
determining if a physical change in the target occurred and is identifiable by the at least one sensor;
analyzing the physical change in the target to determine an impact location; and
presenting the impact location to a user through a user interface.

17. The system of claim 16, wherein at least one sensor is integrated into the target and at least one sensor is integrated into the target environment.

18. The system of claim 16, wherein one of the at least one sensor has thermal imaging abilities.

19. The system of claim 16, wherein the images are analyzed for spatial and thermal properties of the target.

20. The system of claim 16, wherein the target has portions of different coatings of emissivity ratings.
